(19) United States
(12) Patent Application Publication
(10) Pub. No.: US 2011/0171015 A1
(43) Pub. Date: Jul. 14, 2011

(54) CENTRIFUGAL COMPRESSOR AND FABRICATING METHOD THEREOF

(76) Inventor: Tae Jin KANG, Gunpo-si (KR)

(21) Appl. No.: 12/967,523

(22) Filed: Dec. 14, 2010

(30) Foreign Application Priority Data
Jan. 11, 2010 (KR) 10-2010-0002306

(51) Int. Cl. F01D 13/00; B23P 15/00

(52) U.S. Cl. 415/198.1; 29/888.024

(57) ABSTRACT

Provided is a centrifugal compressor. In the centrifugal compressor, a plurality of sub-compressors each of which includes an impeller are connected in parallel to increase a compression capacity, the plurality of sub-compressors are each assembled to a single common shaft that is rotated by a driving unit, and the impellers of the plurality of sub-compressors are disposed in opposing directions. The centrifugal compressor reduces a production cost, and cancels thrusts during driving so as to reduce a loss of a bearing, thereby increasing efficiency of the compressor.

### CROSS-REFERENCE TO RELATED APPLICATION

This application claims priority to Korean Patent Application No. 10-2010-2306, filed on Jan. 11, 2010, and all the benefits accruing therefrom under 35 U.S.C. §119, the contents of which in its entirety are herein incorporated by reference.

### BACKGROUND

1. Field

This disclosure relates to a centrifugal compressor, and more particularly, to an assembling structure for connecting a plurality of sub-compressors connected in parallel.

2. Description of the Related Art

A compressor is a device for compressing gas by applying mechanical energy and is necessary for an air-conditioning apparatus such as a refrigerator to compress a cooling medium. There are different kinds of compressors, including a reciprocating compressor, a screw compressor, a centrifugal compressor, and the like. Particularly, the centrifugal compressor rotating at high speed has been widely used since fluctuation of a discharge gas does not occur and reductions in size and weight are easily achieved.

In general, a centrifugal compressor used in a freezer includes a casing having a cooling medium inlet port on one side, an impeller which is provided inside the casing for compressing a cooling medium flowing therein, a diffuser for converting kinetic energy of the cooling medium compressed by the impeller into pressure energy, and a volute for transferring the cooling medium passing through the diffuser to a discharge duct. The cooling medium flowing through the cooling medium inlet port of the centrifugal compressor is compressed by the impeller and the diffuser, passes through the volute and the discharge duct, and then is transferred to a condenser.

As a method of increasing a compression capacity of the centrifugal compressor, there are a method of providing one large-sized impeller in the compressor and a method of connecting small-sized compressors in parallel. Particularly, a structure of connecting several compressor units in parallel is widely employed. When the compressors are connected in parallel and heat exchangers corresponding to the respective compressors are separately provided and connected in series, a difference in temperature of cooling water passing through a single heat exchanger may be reduced, so that there is an advantage in that a head of each compressor is reduced. In addition, when the head of the compressor is reduced, high efficiency can be achieved.

However, when a plurality of the compressor units are provided in parallel, a plurality of components such as motors are needed for the compressors, so that there is a problem in that manufacturing cost is increased. Particularly, the price of the motor which is a driving unit is high enough to account for a large portion of the price of the compressor. In addition, the prices of components needed for precise processing such as gears and bearings are also high.

### SUMMARY

This disclosure provides a centrifugal compressor in which the number of components is minimized and a plurality of sub-compressors are connected in parallel to achieve low cost and high efficiency and which is easily fabricated.

In one aspect, there is provided a centrifugal compressor including: a plurality of sub-compressors each of which includes an impeller and which are, connected in parallel to increase a compression capacity, wherein the plurality of sub-compressors are each assembled to a single common shaft that is rotated by a driving unit, and the impellers of the plurality of sub-compressors are disposed in opposing directions.

The plurality of sub-compressors may each include casings provided along a longitudinal direction of the common shaft, and each of the casings may be joined to or separated from the adjacent casing by a fastening member.

A sealing member may be provided for maintaining sealing between the plurality of sub-compressors or between the sub-compressors and the driving unit.

The sealing member may be a labyrinth seal.

Each of the casings may be provided with an inlet port through which a compressible medium flows in, and each of the inlet ports may be formed in a longitudinal direction or a lateral direction of the common shaft.

An inlet guide vane for controlling an inflow may be provided on a side of the inlet port.

The common shaft may penetrate through the plurality of sub-compressors and extend outwards, and an extending part of the common shaft may receive an output from the driving unit.

A pinion gear which receives an output from the driving unit may be fixed to the extending part of the common shaft, and a journal supported by a bearing may be fixed to an end portion of the common shaft.

In another aspect, there is provided a fabricating method of a centrifugal compressor, including: providing a common shaft; sequentially assembling a plurality of sub-compressors along an axial direction of the common shaft; assembling a power transmission unit to one end portion of the common shaft; and connecting the power transmission unit to a driving unit.

When assembling the plurality of sub-compressors, impellers of the plurality of sub-compressors may be arranged in opposing directions.

Since the disclosed centrifugal compressor has a structure in which the plurality of sub-compressors are driven by the single common shaft and motor, the production cost thereof is decreased.

In addition, since the plurality of impellers are arranged to oppose one another and thus cancel thrusts during driving, bearing loss may be reduced and the efficiency of the compressor may be increased.

In addition, since the centrifugal compressor is adapted in a vertically divided form in which the components are assembled along the axial direction of the common shaft, the fabrication is performed easily and risk of leakage is reduced.

In addition, since the centrifugal compressor includes the inlet guide vane for each of the sub-compressors, flow rate control is possible.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram illustrating an entire configuration of a centrifugal compressor according to an embodiment;

FIG. 2 is a diagram illustrating a configuration of a first sub-compressor illustrated in FIG. 1;

FIG. 3 is a diagram illustrating a configuration of a second sub-compressor illustrated in FIG. 1; and

FIGS. 4 to 8 are diagrams for explaining an assembling order of the centrifugal compressor according to an embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements.

The shape, size and regions, and the like, of the drawing may be exaggerated for clarity.

Hereinafter, a centrifugal compressor according to an embodiment will be described in detail with reference to the accompanying drawings.

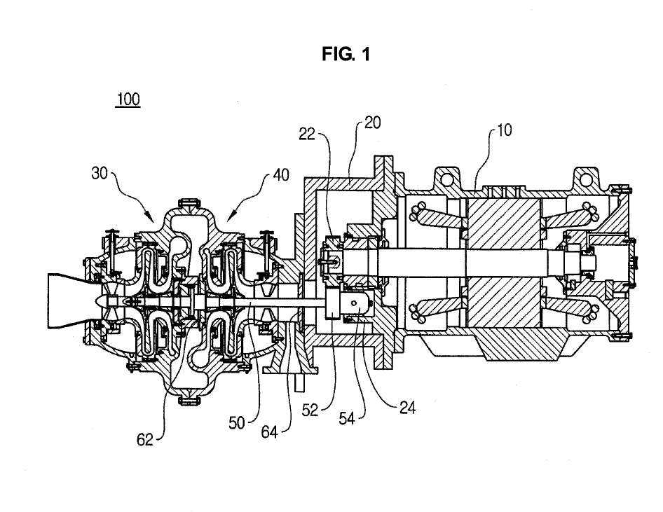

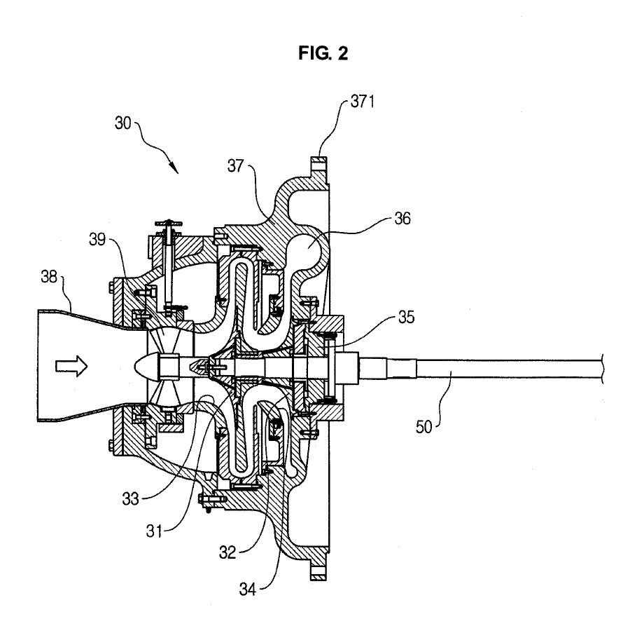

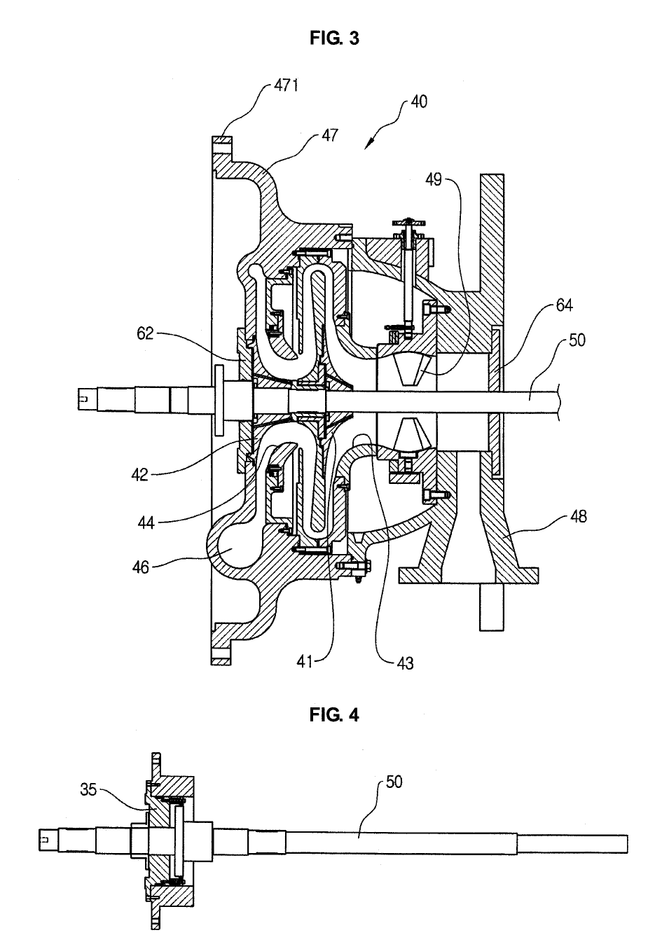

FIG. 1 is a diagram illustrating an entire configuration of a centrifugal compressor according to an embodiment. FIG. 2 is a diagram illustrating a configuration of a first sub-compressor illustrated in FIG. 1. And, FIG. 3 is a diagram illustrating a configuration of a second sub-compressor illustrated in FIG. 1.

First, referring to FIG. 1, a centrifugal compressor 100 includes a motor 10 which is a driving unit, a gearbox 20 for increasing a rotation speed of the motor 10, and first and second sub-compressors 30, 40 which are connected to the gearbox 20 to be rotated. The first and second sub-compressors 30, 40 share a shaft 50. That is to say, the first and second compressors 30, 40 are installed in a row on the single common shaft 50.

The common shaft 50 penetrates through the first and second sub-compressors 30, 40 and extends toward the gearbox 20 in an outer direction. On one side to which the common shaft extends 50, a pinion gear 52 engaged with a driving gear 22 fixed to an output shaft of the motor 10 is mounted. In addition, a journal 54 mounted to a bearing 24 for supporting rotation is mounted to one end portion of the common shaft 50.

Sealing members 62, 64 are respectively provided between the first and second sub-compressors 30, 40 and between the second sub-compressor 40 and the gear-box 20 for maintaining sealing. Labyrinth seals may be used as the sealing members 62, 64.

Referring to FIG. 2, the first sub-compressor 30 includes first-stage and second-stage impellers 31, 32 fixed to the common shaft 50 to be rotated and first-stage and second-stage diffusers 33, 34 disposed at predetermined intervals respectively from the impellers 31, 32. The impellers 31, 32 are arranged so that their front sides face one direction (the left direction in FIG. 2). A bearing 35 for supporting the common shaft 50 is provided on the rear side of the second-stage impeller 32. A Kingsbury bearing may be used as the bearing 35.

A cooling medium compressed by the impellers 31, 32 and the diffusers 33, 34 flows toward a discharge duct through a volute 36.

The first sub-compressor 30 includes a casing 37 through which the common shaft 50 penetrates along its longitudinal direction. A flange portion 371 is provided on one side of the casing 37 to be joined to the second sub-compressor 40.

An inlet port 38 through which the cooling medium flows is provided on the other side of the casing 37 and is disposed in the longitudinal direction of the common shaft 50. An inlet guide vane (IGV) 39 for controlling an inflow of the cooling medium is provided on the inlet port 38 side.

Referring to FIG. 3, the second-compressor 40 includes first-stage and second-stage impellers 41, 42 fixed to the common shaft 50 to be rotated and first-stage and second-stage diffusers 43, 44 disposed at predetermined intervals respectively from the impellers 41, 42. The impellers 41, 42 are arranged so that their front sides face the other direction (the right direction in FIG. 3). That is, the impellers 31, 32 of the first sub-compressor 30 and the impellers 41, 42 of the second sub-compressor 40 face opposing directions (opposite directions). Such arrangement of the impellers cancels thrusts during driving and thus reduces damage of the bearing and increases the efficiency of the compressor.

A cooling medium compressed by the impellers 41, 42 and the diffusers 43, 44 flows toward the discharge duct through a volute 46. Since the first and second sub-compressors 30, 40 are connected in parallel, the cooling medium discharged to the volute 36 of the first sub-compressor and the cooling medium discharged to the volute 46 of the second sub-compressor are combined in the discharge duct. Thus, the compression capacity is increased.

The second sub-compressor 40 includes a casing 47 through which the common shaft 50 penetrates along its longitudinal direction. A flange portion 471 is provided on one side of the casing 47 to be assembled to the first sub-compressor 30. Therefore, the flange portion 371 of the first sub-compressor 30 and the flange portion 471 of the second sub-compressor 40 are made to be in close contact with each other and are joined by fastening members such as bolts and nuts.

Sealing members 62, 64 are respectively provided at the rear of the second-stage impeller 42 and at a front end portion of the casing 471 for maintaining sealing.

An inlet port 48 through which the cooling medium flows is provided at a side surface of the casing 47 in a direction perpendicular to the common shaft 50. Since the common shaft 50 extends outwards in the longitudinal direction for connection to the gearbox 20, the inlet port 48 may be provided in the lateral direction. An inlet guide vane 49 for controlling an inflow of the cooling medium is provided on the inlet port 48 side.

Although the first and second sub-compressors 30, 40 are connected in parallel, since the shaft 50 is shared, fabrication can be performed using the single motor 10 and the single shaft 50. Thus, the number of components is reduced, and a production cost is also reduced.

In the above-described embodiment, two two-stage sub-compressors are connected in parallel. However, this disclosure is not limited thereto, and the number of sub-compressors and the number of stages thereof may be modified variously.

FIGS. 4 to 8 are diagrams for explaining an assemblage order of the centrifugal compressor according to an embodiment.

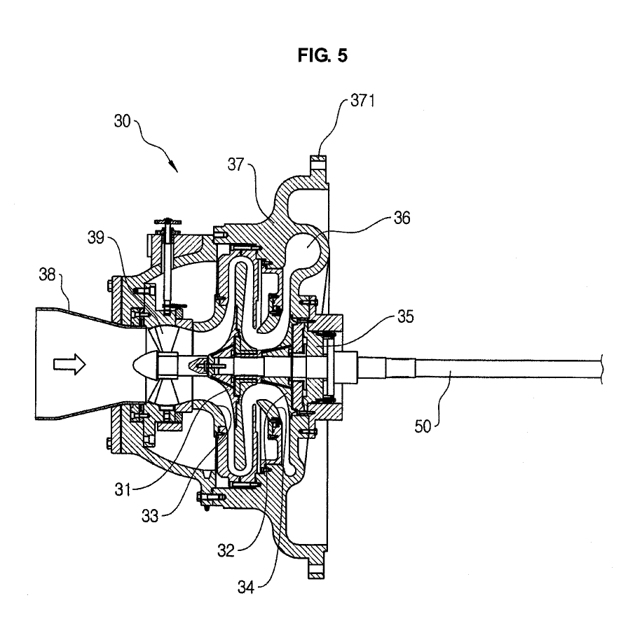

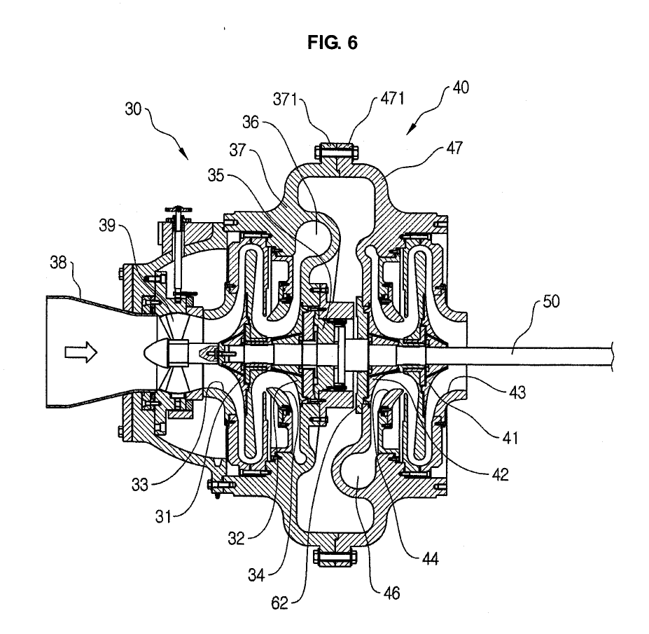

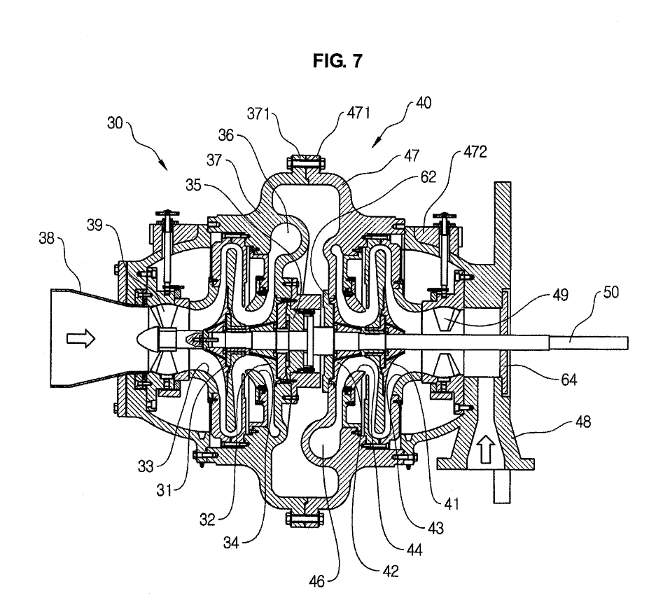

First, referring to FIGS. 4 and 5, the bearing 35 is assembled to the common shaft 50, and the first sub-compressor 30 is provided along an axial direction from one side of the common shaft 50. Next, as illustrated in FIGS. 6 and 7, the second sub-compressor 40 is provided along the axial direction from the other side of the common shaft 50. The flange portion 471 of the casing 47 of the second sub-compressor 40 is joined to the flange portion 371 of the casing 37 of the first sub-compressor 30 by the fastening members. The casings 37, 47 of the first and second sub-compressors 30, 40 may be modified to have structures in which their adjacent portions are easily fastened to each other.

At the second sub-compressor 40, an inlet frame 472 may be formed separately on the casing 47. Thus, after the assembling of the casing 47, the inlet frame 472 is joined to the casing 47 by fastening members. In addition, the sealing member 64 is provided at a right end portion of the inlet frame 472 for maintaining sealing.

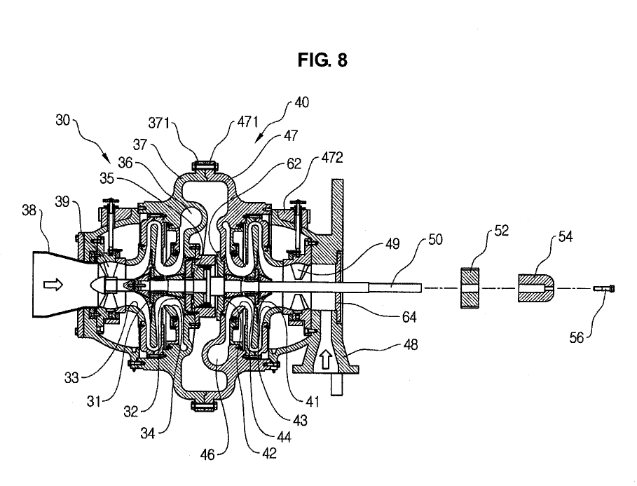

Next, as illustrated in FIG. 8, the pinion gear 52 is assembled to the common shaft 50, and the journal 54 which is a part supported by the bearing 24 is assembled thereto, and then the bolt 56 is fastened to the common shaft 50, such that the components are integrated with the common shaft 50. Keys are inserted between the shaft 50 and the pinion gear 52 and between the common shaft 50 and the journal 54 for fixation.

After the first and second sub-compressors 30, 40 are sequentially assembled to the common shaft 50, the fabrication of the centrifugal compressor 100 is completed by connecting the pinion gear 52, which is a power transmission unit, to the driving gear 22 connected to the motor 10.

As described above, the centrifugal compressor according to this embodiment is adapted in a vertically divided form in which the components are assembled along the axial direction. Therefore, there are advantages in that the risk of leakage is reduced, an operation of aligning centers is easy, and thus the fabrication operation is easy.

In addition, in the centrifugal compressor 100 according to the embodiment, the structures of the plurality of sub-compressors may be changed to be assembled on the single common shaft. Thus, the number of components is reduced and the production cost is reduced.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A centrifugal compressor comprising:
a plurality of sub-compressors each of which includes an impeller and which are connected in parallel to increase a compression capacity,
wherein the plurality of sub-compressors are each assembled to a single common shaft that is rotated by a driving unit, and
the impellers of the plurality of sub-compressors are disposed in opposing directions.

2. The centrifugal compressor according to claim 1,
wherein the plurality of sub-compressors each include casings provided along a longitudinal direction of the common shaft, and
each of the casings may be joined to or separated from the adjacent casing by a fastening member.

3. The centrifugal compressor according to claim 2, wherein a sealing member is provided for maintaining sealing between the plurality of sub-compressors or between the sub-compressors and the driving unit.

4. The centrifugal compressor according to claim 3, wherein the sealing member is a labyrinth seal.

5. The centrifugal compressor according to claim 2,
wherein each of the casings is provided with an inlet port through which a compressible medium flows in, and
each of the inlet ports is formed in a longitudinal direction or a lateral direction of the common shaft.

6. The centrifugal compressor according to claim 5, wherein an inlet guide vane for controlling an inflow is provided on a side of the inlet port.

7. The centrifugal compressor according to claim 1,
wherein the common shaft penetrates through the plurality of sub-compressors and extends outwards, and
an extending part of the common shaft receives an output from the driving unit.

8. The centrifugal compressor according to claim 7,
wherein a pinion gear which receives an output from the driving unit is fixed to the extending part of the common shaft, and
a journal supported by a bearing is fixed to an end portion of the common shaft.

9. A fabricating method of a centrifugal compressor, comprising:
providing a common shaft;
sequentially assembling a plurality of sub-compressors along an axial direction of the common shaft;
assembling a power transmission unit to one end portion of the common shaft; and
connecting the power transmission unit to a driving unit.

10. The fabrication method according to claim 9, wherein, in said assembling of the plurality of sub-compressors, impellers of the plurality of sub-compressors are arranged in opposing directions.
